(19) United States
(12) Patent Application Publication
(10) Pub. No.: US 2019/0306790 A1
(43) Pub. Date: Oct. 3, 2019

(54) METHOD AND APPARATUS FOR MANAGING TARGET WAKE TIME IN A COMMUNICATION NETWORK

(71) Applicant: QUALCOMM Incorporated, San Diego, CA (US)

(72) Inventors: Sanoop Kottontavida, San Jose, CA (US); Xiaolong Huang, San Jose, CA (US); Yongchun Xiao, San Jose, CA (US); Naveen Gangadharan, San Jose, CA (US); Srinivas Katar, Fremont, CA (US); Sandip Homchaudhuri, San Jose, CA (US); James Simon Cho, Mountain View, CA (US)

(21) Appl. No.: 15/938,784

(22) Filed: Mar. 28, 2018

(51) Int. Cl. H04W 52/02; H04W 28/02; H04W 76/28; H04W 72/12

(52) U.S. Cl. CPC H04W 52/0206; H04W 28/0289; H04W 84/12; H04W 76/28; H04W 72/1252; H04W 28/0284

(57) ABSTRACT

Various aspects of the disclosure provide for Target Wake Time (TWT) slot scheduling in a communication network. The various aspects includes determining a number of stations in the basic service set (BSS) of an access point (AP) exceeding a minimum number of stations, determining whether to establish TWT slot scheduling for at least one or more of the stations based on one or more operational condition of the communication network, and establishing a TWT slot scheduling of the one or more of the stations if the one or more operational condition of the communication network, individually or collectively, satisfy a threshold.

### TECHNICAL FIELD

This disclosure relates generally to wireless networks, and specifically to managing the target wake time of the network including legacy and advanced stations.

### DESCRIPTION OF THE RELATED TECHNOLOGY

The present disclosure relates generally to wireless communications, and specifically to techniques for scheduling, modifying, and removing target wake time communications scheduling between a wireless station (STA) and an access point (AP) that may provide improved STA power save routine, signal quality, data rate, reliability, quality of service (QoS) to the STA.

The deployment of wireless local area networks (WLANs) in the home, the office, and various public facilities is commonplace today. Such networks typically employ a wireless AP that connects a number of wireless STAs in a specific locality (e.g., home, office, public facility, etc.) to another network, such as the Internet or the like. In a dense WLAN deployment, a number of STAs may be in constant communication with each AP. An STA, in a conventional WLAN architecture, may transmit and receive frames at will, as needed, or according to a schedule set up by the AP. Such loose communications scheduling may present problems when network usage is high and congestion caused by the high network usage may result in communications collisions, affecting both throughput and power usage. In such cases, for example, an AP may struggle to receive, process, and transmit a high volume of packets from a myriad of sources, which may result in frames or packets being dropped or misinterpreted and a degraded quality of service (QoS) for a user.

To alleviate the problem of dense deployments, and among a number of advanced 802.11 Standards and advanced stations complying with such Standards, WLANs implementing IEEE 802.11ah and newer standards (e.g., IEEE 802.11ax) may make use of techniques for Target Wake Time (TWT) communications scheduling that are supported in those standards. TWT could also be used in a peer-to-peer communication between two supporting devices without relying on a specific Standard. TWT allows an AP to define a specific time or time intervals for each connected STA to enter into a wake state in order to access or exchange information with the AP. For example, the AP may stipulate a communications interval duration for each connected STA. For example, an AP centralizes the transmission/reception operations for a groups of STAs to minimize collisions in a dense deployment, thereby reducing contention and saving power. The use of TWT may be negotiated between an AP and each individual STA. During the setup of a schedule for TWT communications set up, an STA and an AP exchange information that includes an expected activity duration to allow the AP to control the amount of overlap among competing STAs and schedule the various STAs in specific communication slots. The scheduling of TWT communications may be used to reduce network energy consumption, as STAs that use it can reduce power consumption by entering into a sleep (or similar) state until their corresponding TWT slot is available.

However, conventional scheduling of TWT communications may not account for the need to meet power, throughput, and latency requirements in dense environments. In these conditions, conventional scheduling of TWT communications may not address how to implement voice over Internet Protocol (VoIP), legacy stations operating in the same environment with the advanced stations, handle continuous changes in the amount of traffic, handle the need to send or receive additional information when an allocated period is terminated or outside an allocated time period, and/or handle off-channel operations. As such, techniques for implementing the scheduling and operation of TWT communications that address some of the issues that arise during dense deployments are desirable.

### SUMMARY

Aspects of the present disclosure address the above-identified problems by implementing techniques that allow the scheduling and operation of TWT communications in a manner that is responsive to network operating parameters that may occur in dense WLAN deployments. These aspects may include the use of a method and an accompanying apparatus for Target Wake Time (TWT) slot scheduling in a communication network. The process includes determining a number of stations in the basic service set (BSS) of an access point (AP) exceeding a minimum number of stations, determining whether to establish TWT slot scheduling for at least one or more of the stations based on one or more operational condition of the communication network, and establishing a TWT slot scheduling of the one or more of the stations if the one or more operational condition of the communication network, individually or collectively, satisfy a threshold.

Furthermore, the one or more operational condition of the communication network includes at least one of network congestion level, interference level, transmit queue depth of one or more of the stations, number of receive packets from one or more of the stations during a particular period of time, latency requirement of an application being used by one or more of the stations, and allowing use of the communication medium among the stations based on an air time fairness criteria.

Furthermore, the one or more operational condition of the communication network includes congestion and interference levels of the communication network, and satisfying the threshold includes the congestion level to be above a threshold and the interference level be below a threshold.

Furthermore, when the one or more operational condition of the communication network, individually or collectively, satisfy the threshold, determining if the number of stations in the BSS of the access point AP includes at least one legacy station, and assigning at least one TWT slot to the least one legacy station.

Furthermore, when the one or more operational condition of the communication network, individually or collectively, satisfy the threshold, determining if the number of stations in the BSS of the access point AP includes at least one MU-MIMO station, and assigning at least one TWT slot to the least one MU-MIMO station.

Furthermore, when the one or more operational condition of the communication network, individually or collectively, satisfy the threshold, rescheduling the TWT slots for at least one or more of the stations based on whether a communication property at one or more the stations has changed after a last established TWT slot scheduling of the one or more of the stations.

Furthermore, the rescheduling the TWT slots includes removing, adding, and/or modifying the scheduled TWT slots to one or more of the stations.

Furthermore, when the one or more operational condition of the communication network, individually or collectively, satisfy the threshold, rescheduling the TWT slots for at least one or more of the stations based on a request from the one or more stations. In addition, the request from the one or more stations includes at least one of TWT setup with DEMAND command, TWT setup with REQUEST/SUGGEST command, TWT setup with REJECT command, and TWT setup with PAUSE/UNPAUSE command.

Furthermore, the established TWT slot scheduling of the one or more of the stations includes assigning more than one TWT slot and/or TWT slots with a particular duty cycle to a particular station of the one or more stations based on data communication requirement of an application being used by the particular station. In addition, the data communication requirement of the application includes communication latency requirement, and amount of data being communicated in one beacon interval.

### BRIEF DESCRIPTION OF THE DRAWINGS

Various aspects of apparatuses and methods will now be presented in the detailed description by way of example, and not by way of limitation, with reference to the accompanying drawings, wherein:

FIG. 1 shows a diagram illustrating an example of a wireless local area network (WLAN) deployment in connection with various techniques described herein.

FIG. 2 shows a diagram 200 associated with baseline aspects of scheduling TWT communications between an AP and a group of STAs.

FIG. 3 shows a timeline diagram 300 illustrating baseline aspects for establishing individual TWT communications between an AP and one or more individual STAs that are solicited or unsolicited.

FIG. 4 depicts a process flow for the AP to use in order to determine whether establishing a TWT in its BSS would result in an efficient use of the medium.

FIG. 5 depicts a process flow that may be used in conjunction with the process flow depicted in FIG. 4 depicts a process flow which the AP has begun establishing TWT agreements with the STAs in its BSS, and communicate setting the TWT mode to positive (TWT=Yes).

FIG. 6 depicts an exemplary TWT frame having ten slots with various possible TWT assignment formulated and formed in accordance with various aspects of the disclosure is shown.

FIG. 7 depicts an exemplary process flow for AP to manage a TWT request from an STA in accordance with various aspects of the disclosure.

FIG. 8 shows a diagram that describes hardware components and subcomponents of an STA 115 for implementing the various features described herein in connection with TWT communications, including one or more methods described and claimed herein in accordance with various aspects of the present disclosure.

FIG. 9 shows a diagram that describes hardware components and subcomponents of an AP 105 as described herein in accordance with various aspects of the present disclosure.

### DETAILED DESCRIPTION

Various aspects of the present disclosure allow an access point (AP) to set up, adjust, and/or tear down scheduling of target wake time (TWT) communications in dense network deployments. As described herein, TWT or TWT communications refer to specific times or sets of times that are scheduled for STAs to wake in order to exchange frames (e.g., a bidirectional exchange) with an AP or with another STA. TWT or TWT communications allow for the centralization of transmissions and receptions for a group of STAs minimizing the collisions that may occur in, for example, IEEE 802.11ax, thereby reducing the amount of power that may be wasted in a densely populated medium. These aspects may include techniques for identifying or obtaining one or more network parameters for determining the scheduling of the STAs in TWT, thereby establishing the STAs wake up and sleep periods. The process may involve determining whether one or more network parameters meet certain metrics. The following listing includes a non-limiting number of parameters that may be used in the process.

Congestion
Congestion may be measured per slot time and is based on the amount of time that the medium is not free for transmission by a device. The congestion may be measured based on the Network Allocation Vector (NAV) that may be communicated by the STAs. NAV allows stations to indicate the amount of time (e.g. number of time slots/frames) required for transmission of required frames immediately following the current frame, which would reserve the medium as busy for the indicated number of frames. As the number of NAV increases, there would be fewer opportunities for other STAs to initiate a transmission, and therefore, it would be more efficient for such other STAs to remain in a sleep state more often than otherwise. The capability of the AP may also be considered. For example, an AP may be equipped with hardware capability that allows it to communicate with more STAs than otherwise. Therefore, the parameter Congestion may also be measured based on the capability of the AP handling a number of communication flows at the same or overlapping times. The Congestion parameter may be compared to a threshold Congestion parameter in the process in order to determine whether a congested state has been reached or nearly has been reached.

Interference
Interference may be measured per slot time. The interference may be measured in a number of ways, such as determining the amount of communication traffic that is carried by the legacy devices. Since legacy STAs operate based on the older version(s) of the 802.11 Standard, they do not need to transmit based on TWT, and as a result they may appear as causing interference when communicating among the advanced STAs. In addition, the transmissions from certain STAs that are operating with an adjacent and overlapping APs may also appear as interference. The interference may be measured based on the number of transmission errors during a time slot. The number of transmission error may be compared to a threshold to determine whether the interference has reached an unacceptable level.

Number of Connected STAs
TWT may not be necessary if the AP is connected to few number of STAs with sporadic transmissions. However, as the number of STAs connected to the AP increases, the need to establish a TWT becomes necessary. As such, when the number of connected STAs reaches a threshold, the TWT operation by the AP may also be triggered. There may be considered a minimum number of STAs required to start the TWT mode of operation. However, under certain circumstances where the AP operation requires use of TWT even with one associated STA.

Transmit Queue Depth
The transmit Queue Depth may be measured based on each STA connection (i.e. Peer property). As the number of data packets queued for transmission increases, more time slots may be needed in TWT. Considering one STA may be managing several applications (i.e. peers) at the same time, each application may have a unique Traffic ID (TID). The data packet queued for each TID (TIDQ), collectively or individually, may be compared to a threshold to determine if TWT should be modified accordingly.

Number of RX Packets
Certain applications (i.e. peers) may require transmission and reception of a large number of data packets. As such, the need to modify TWT may be based on the number of data packets received at the AP from a specific STA associated with the TID. If the number of received packets increases beyond a threshold, the AP may modify the TWT accordingly. The STA may communicate for example a Buffer Status Report parameter indicating the remaining number of packets that it needs to transmit.

Latency
Certain applications (i.e. peers) may require transmission and reception of data packets with stringent latency requirement. For example, if the application is Voice over IP communication, the latency requirement is more stringent than other applications, such as downloading a real-time video. As such, the need to modify TWT may be based on the latency requirement of data packets received at the AP. If the latency requirement increases beyond a threshold, the AP may modify the TWT accordingly. Certain application may communicate their latency requirements in the process which may be used for modifying the TWT. In another aspect, certain communication links do not require an Acknowledgement protocols and others do. Generally, the latency requirement is more stringent for communications that do not require an Acknowledgment protocols. The TWT may be modified to accommodate such different latency requirements.

Air Time Fairness
To avoid exclusion of a STA for a long period of time in TWT, certain STAs may be included in TWT from time to time based on a weighting factor, and thus allowing such STAs to have an opportunity to communicate in accordance with the TWT. For example, certain applications run by such STAs may need to communicate data sporadically, like reporting the air temperature. For such applications, Air Time Fairness may apply a particular weighting factor to make sure the application (i.e. Peer) has at least one or more opportunity to transmit and communicate with the AP. An STA may run a number of applications at the same time. The Air Time Fairness may apply a different weighting factor to each application (i.e. Peer).

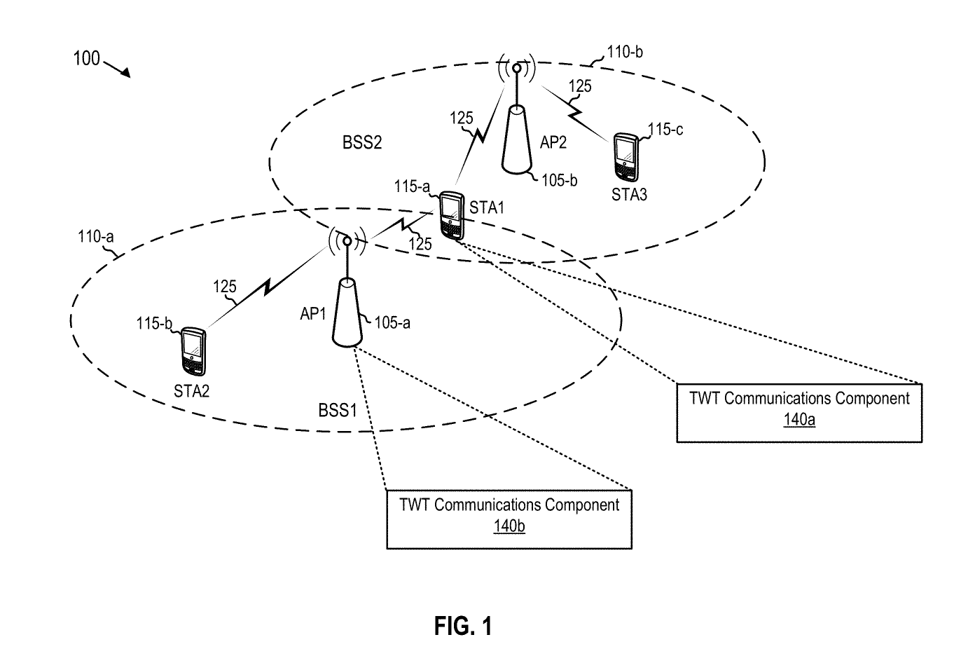

FIG. 1 shows a diagram 100 illustrating an example of a wireless local area network (WLAN) deployment in connection with various techniques described herein. Although limited, the WLAN deployment in FIG. 1 may be representative of a small portion of a dense WLAN deployment. The WLAN may include one or more access points (APs) and one or more mobile or wireless stations (STAs) associated with a respective AP. In this example, there are two APs deployed: AP1 105-a in basic service set 1 (BSS1) and AP2 105-b in BSS2, which may be referred to as an OBSS. AP1 105-a is shown as having at least two associated STAs (STA1 115-a and STA2 115-b) and coverage area 110-a. STA1 115-a may also be in the coverage area 110-b of AP2 105-b. Normally, an STA is associated with only one AP, but the association may change from one AP to another. Therefore, STA1 115-a may drop its association with AP1 105-a and associate with AP2 105-b. As such, AP2 105-b is shown at certain times having at least two associated STAs (STA1 115-a and STA3 115-c) and coverage area 110-b. The STAs and AP associated with a particular BSS may be referred to as members of that BSS. One or more of such STAs may operate in accordance with a Legacy Standard (i.e. legacy STA) and others in accordance with one or more of the advanced 802.11 Standards (i.e. advanced STA). In the example of FIG. 1, the coverage area of AP1 105-a may overlap part of the coverage area of AP2 105-b such that STA1 115-a may be within the overlapping portion of the coverage areas. The number of BSSs, APs, and STAs, and the coverage areas of the APs described in connection with the WLAN deployment of FIG. 1 are provided by way of illustration and not of limitation.

In some examples, the APs (e.g., AP1 105-a and AP2 105-b) shown in FIG. 1 are generally fixed terminals that provide backhaul services to STAs 115 within its coverage area or region. In some applications, however, the AP may be a mobile or non-fixed terminal. The STAs (e.g., STA1 115-a, STA2 115-b and STA3 115-c) shown in FIG. 1, which may be fixed, non-fixed, or mobile terminals, utilize the backhaul services of their respective AP to connect to a network, such as the Internet. Examples of an STA include, but are not limited to: a cellular phone, a smart phone, a laptop computer, a desktop computer, a personal digital assistant (PDA), a personal communication system (PCS) device, a personal information manager (PIM), personal navigation device (PND), a global positioning system, a multimedia device, a video device, an audio device, a device for the Internet-of-Things (IoT), or any other suitable wireless apparatus. An STA may also be referred to by those skilled in the art as: a subscriber station, a mobile unit, a subscriber unit, a wireless unit, a remote unit, a mobile device, a wireless device, a wireless communications device, a remote device, a mobile subscriber station, an access terminal, a mobile terminal, a wireless station, a remote terminal, a handset, a user agent, a mobile client, a client, user equipment (UE), or some other suitable terminology. An AP may also be referred to as: a wireless router, a base transceiver station, a radio base station, a radio transceiver, a transceiver function, or any other suitable terminology. The various concepts described throughout this disclosure are intended to apply to all suitable wireless apparatus regardless of their specific nomenclature.

Each of STA1 115-a, STA2 115-b, and STA3 115-c may be implemented with a protocol stack. The protocol stack can include a physical layer for transmitting and receiving data in accordance with the physical and electrical specifications of the wireless channel, a data link layer for managing access to the wireless channel, a network layer for managing source to destination data transfer, a transport layer for managing transparent transfer of data between end users, and any other layers necessary or desirable for establishing or supporting a connection to a network.

Each of AP1 105-a and AP2 105-b can include software applications and/or circuitry to enable associated STAs to connect to a network via one or more communications links, and depicted collectively as communication link 125. The APs can send frames or packets to their respective STAs and receive frames or packets from their respective STAs to communicate data and/or control information (e.g., signaling). Each of AP1 105-a and AP2 105-b can establish a communications link 125 with an STA that is within the coverage area of the AP. Communications link 125 can comprise communications channels that can enable both uplink and downlink communications. When connecting to an AP, an STA can first authenticate itself with the AP and then associate itself with the AP. Once associated, a communications link may be established between the AP and the STA such that the AP and the associated STA may exchange frames, packets, or messages through a direct communications channel. It should be noted that the wireless communication system, in some examples, may not have a central AP (e.g., AP1 105-a or AP2 105-b), but rather may function as a peer-to-peer network between the STAs. Accordingly, the functions of an AP described herein may alternatively be performed by one or more of the STAs.

Wireless networks with dense deployments, for example, deployments in which larger numbers of STAs try to access and/or maintain communications links (e.g., communications link 125) with an AP, may experience high levels of congestion as many STAs may try to access the medium at the same time and/or overlapping times. Collisions caused by congested environments may result in, among other things, large amounts of wasted power by STAs as they continue to try to access the medium, while additionally adding to potential interference in the medium. The techniques described in this disclosure may be used to reduce contentions in a densely populated medium to save power by taking into consideration a number of communication parameters, including congestion, interference, number of connected STAs, transmit queue depth, number of received packets, latency and/or air time fairness as outlined throughout this disclosure. Accordingly, features of the present disclosure enable an AP (e.g. AP1 105-a and AP2 105-b) to set up, modify, or tear down TWT communications based on one or more of such network parameters.

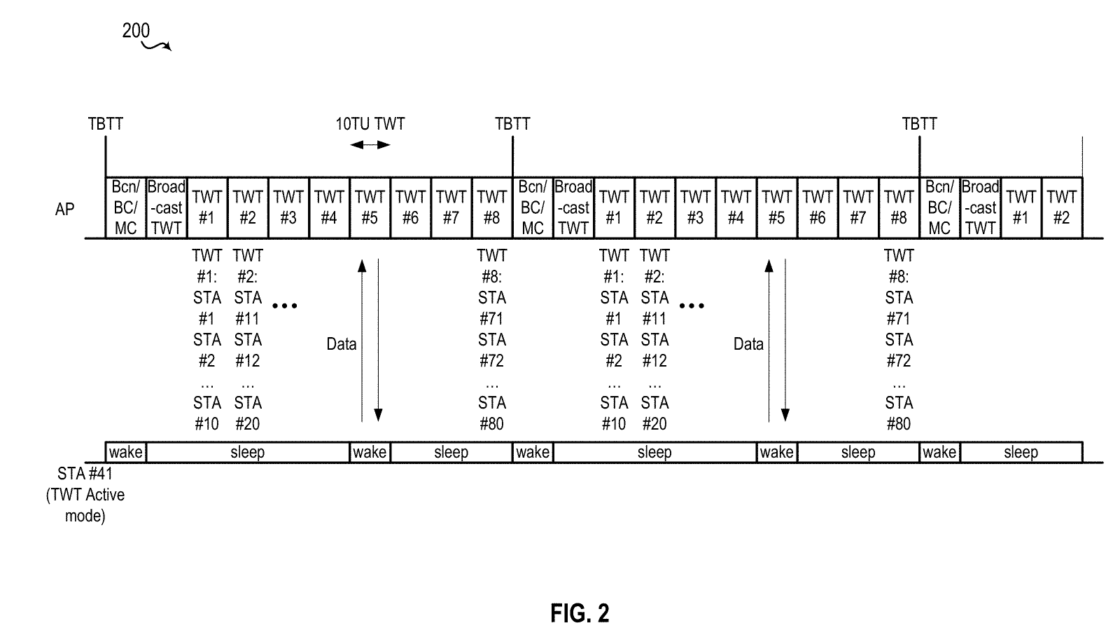

FIG. 2 shows a diagram 200 associated with baseline aspects of scheduling TWT communications between an AP and a group of STAs. The STAs in the diagram 200 may correspond to the STAs described in FIG. 1; and similarly, the AP in the diagram 200 may correspond to any one of the APs in FIG. 1. The scheduling of TWT communications may provide a specific time or set of times for individual STAs to change their operating mode to a wake state in order to exchange frames or packets with other STAs or an AP. In the illustrated example in FIG. 2, there is shown an interval identified as a target beacon transmission time (TBTT) that includes 10 time units (TUs) or slots. A first slot is associated with the transmission of a beacon (bcn) and broadcast/multicast packet transmission (BC/MC), a second slot is associated with an optional TWT broadcast agreement, and following eight (8) TWT slots (TWT #1, . . . , TWT #8) are associated with different allocations of times for different STAs, where each of these eight TWT slots can handle transmission to a number of STAs, for example up to 10 STAs. Each STA may awake only during its corresponding or specific TWT slot to perform bidirectional data traffic with an AP or with another STA.

The scheduling of TWT communications may be based on broadcast TWT and/or individual type TWT. As shown and described in the diagram 200, the second slot is used for broadcast TWT for a number of STAs, and other slots are used for an “individual” type TWT which is implemented for the different STAs in a group of STAs where each STA establishes a TWT scheduling agreement with the AP. These individual TWT scheduling agreements may have overlapping service periods or wake durations. That is, two or more individual agreements may align such that they may have the same wakeup timeline as illustrated in FIG. 2. For example, during the slot TWT #1 (also referred to as TWT service period or TWT SP), STA #1, . . . , STA #10 may be scheduled to wake and may therefore transmit/receive data with the AP during the specific time interval of the slot TWT #1. During the slot TWT #2, STA #11, . . . , STA #20 may be scheduled to wake and may therefore transmit (Tx)/receive (Rx) data with the AP during the specific time interval of the slot TWT #2. In the diagram 200, as an example, an STA #41 wakes up when its active mode TWT slot (TWT #5) occurs in order to perform a bidirectional data exchange with the AP. The AP can coordinate or centralize control of the TWT slots and the STAs associated with the TWT slots in accordance with the interval between TBTTs and therefore may manage which STAs perform transmission/reception of data at any given point in time, in accordance with various aspects of the disclosure.

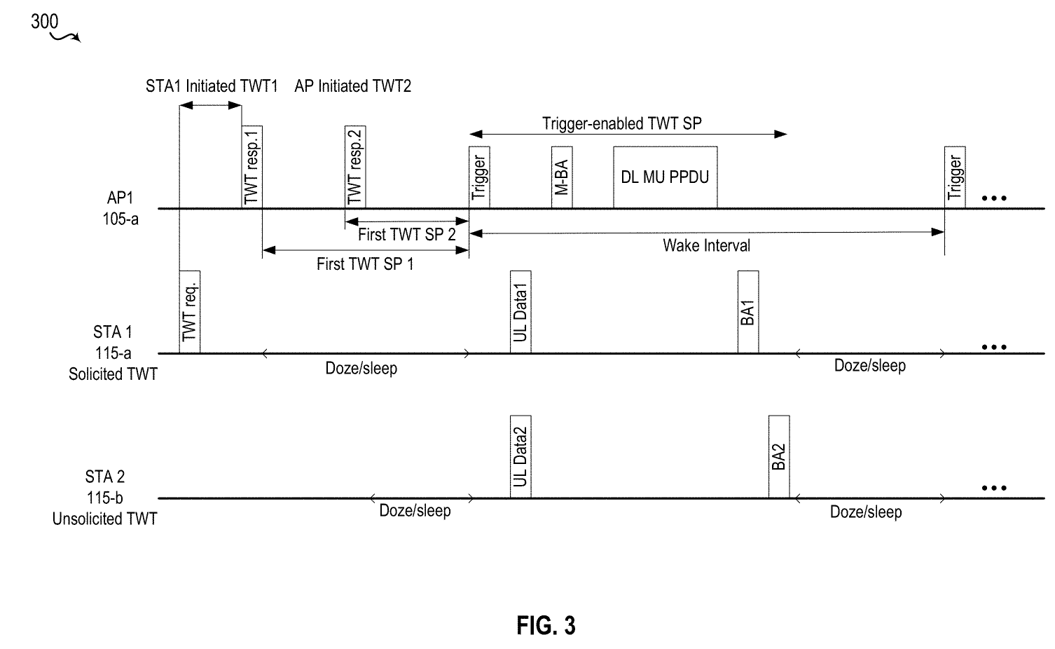

FIG. 3 shows a timeline diagram 300 illustrating baseline aspects for establishing individual TWT communications between an AP and one or more individual STAs that are solicited or unsolicited. In this example, the AP is AP1 105-a and the STAs are STA1 115-a and STA2 115-b, which as shown in FIG. 1 form a BSS1. Solicited TWT communications may occur when an STA initiates or sets up TWT communications with an AP. For example, the STA1 115-a may suggest or request some TWT parameters, which the AP1 105-a may accept, reject, or adjust/change. The STA1 115-a may therefore transmit a request (TWT req.) to the AP1 105-a, which in turn may send a response (TWT resp. 1) to the STA1 115-a as part of a TWT 1 initiated by the STA1 115-a. After establishing the TWT communications (e.g., TWT 1), the STA1 115-a may enter a doze/sleep state until the designated wake up interval or slot in connection with a first TWT service period (SP) 1. An STA may also be subject to scheduling of unsolicited TWT communications by an AP. Unsolicited TWT communications may occur when the AP sends unsolicited TWT frames or packets to the STA, which the STA has to accept. If the STA is unable to sustain the unsolicited TWT communications, the STA may later reject the TWT communications. For example, in the diagram 300, the AP1 105-a may send an indication (TWT resp. 2) to the STA2 115-b as part of a TWT2 initiated by the AP1 105-a. After establishing the TWT communications (e.g., TWT 2), the STA2 115-b may enter a doze/sleep state until the designated wake up interval or slot in connection with a first TWT service period (SP) 2. In some aspects, the AP 105 may employ unsolicited TWT communications scheduling to join STAs into a broadcast TWT group. For example, STA 2 may be joined to a TWT group with STA 1 using unsolicited communications scheduling, so that both STA 1 and STA 2 wake up and transmit/receive during the same time periods. After the first TWT SP1 and the first TWT SP2, a trigger is generated by the AP1 105-a that initiates a trigger-enabled TWT SP and wake interval. During the trigger-enabled TWT SP, the STA1 115-a may transmit or send data to the AP1 105-a (e.g., UL Data 1) and the STA2 115-b may transmit or send data to the AP1 105-a (e.g., UL Data 2). The transmission of UL Data 1 and UL Data 2 may occur at the same time. In response, the AP1 105-a may transmit or send a multiple block acknowledgment (M-BA) followed by downlink, multi-user PLCP protocol data unit (DL MU-PPDU). The STA1 115-a may respond with a block acknowledgment (BA1) while the STA2 115-b may subsequently respond with a block acknowledgement (BA2). Also shown in the diagram 300 is a next trigger after the end of the wake interval. As illustrated in the diagram 300, the AP1 105-a may bucket multiple individual TWT communications so that different STAs exchange data in the same time slots. However, the TWT communications for each STA may need to be set up individually, whether it is done in a solicited fashion by the STA or in an unsolicited fashion by the AP.

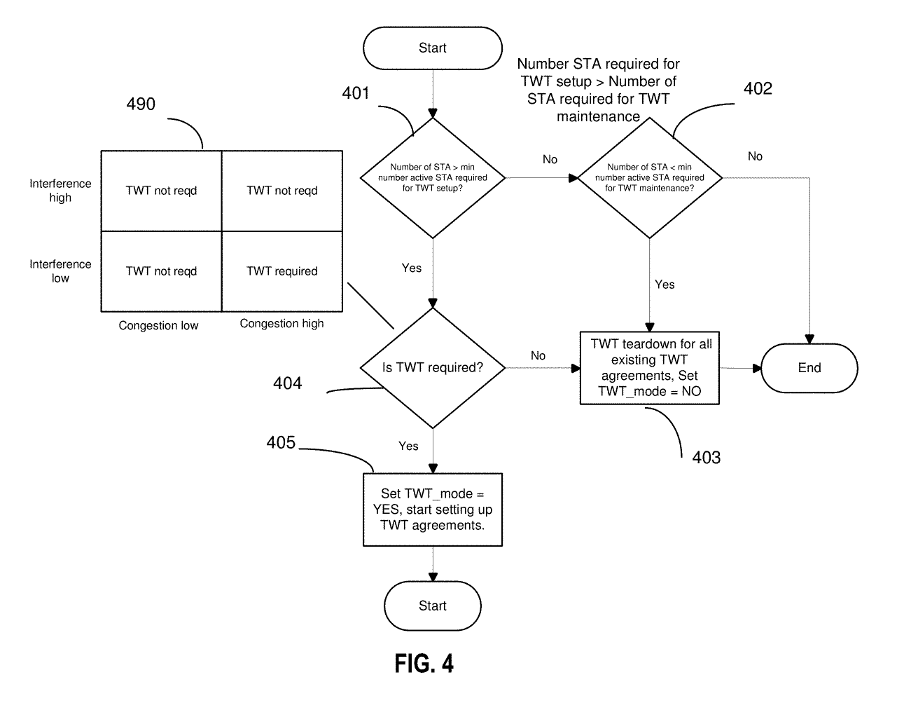

FIG. 4 depicts a process flow 400 for the AP to use in order to determine whether establishing a TWT in its BSS would result in an efficient use of the medium. At step 401, AP determines the number of active STAs in its BSS, and compares the number of active STAs to a threshold minimum number of active STAs required for TWT set up. If the number of active STAs is less than the threshold minimum number of active STAs required for TWT set up, process 400 flows to step 402. At step 402, the number of STAs in the same BSS is compared to a threshold minimum number of active STAs required for TWT maintenance. If the number of STAs in the same BSS is less than the threshold minimum number of active STAs required for TWT maintenance, process flow 400 flows to step 403, otherwise, the process flow 400 would maintain the same TWT, and does not change the existing TWT agreements with various included STAs. At step 403, the AP tears down the existing TWT agreements with the included STAs, and communicate setting the TWT mode to negative (TWT=No).

At step 401, if the number of active STAs is more than the threshold minimum number of active STAs required for TWT set up, process 400 flows to step 404. At step 404, AP determines whether establishing a TWT would be beneficial for an efficient use of the medium by evaluating a number of network parameters and compared them to one or more particular thresholds. Based on such collective evaluations and comparisons, the AP decides whether establishing a TWT is required at step 404. Such a collective evaluation and comparisons is shown in a true/false diagram 490. As an example, two network parameters are considered as shown in diagram 490, namely: Congestion and Interference. Other network parameters may also be included, but for simplicity, only two network parameters are used for the explanation. In this example, establishing a TWT would be required only if the Congestion level high (i.e. above its threshold) and the Interference level is low (below its threshold), as shown in true/false diagram 490. At step 404, if TWT is not required, the process flow 400 flows to step 403 which would allow the AP to tear down the existing TWT agreements with the included STAs, and setting the TWT mode to negative (TWT=No). At step 404, if TWT is required, the process flow 400 flows to step 405, and the AP begins establishing TWT agreements with the STAs in its BSS, and setting the TWT mode to positive (TWT=Yes).

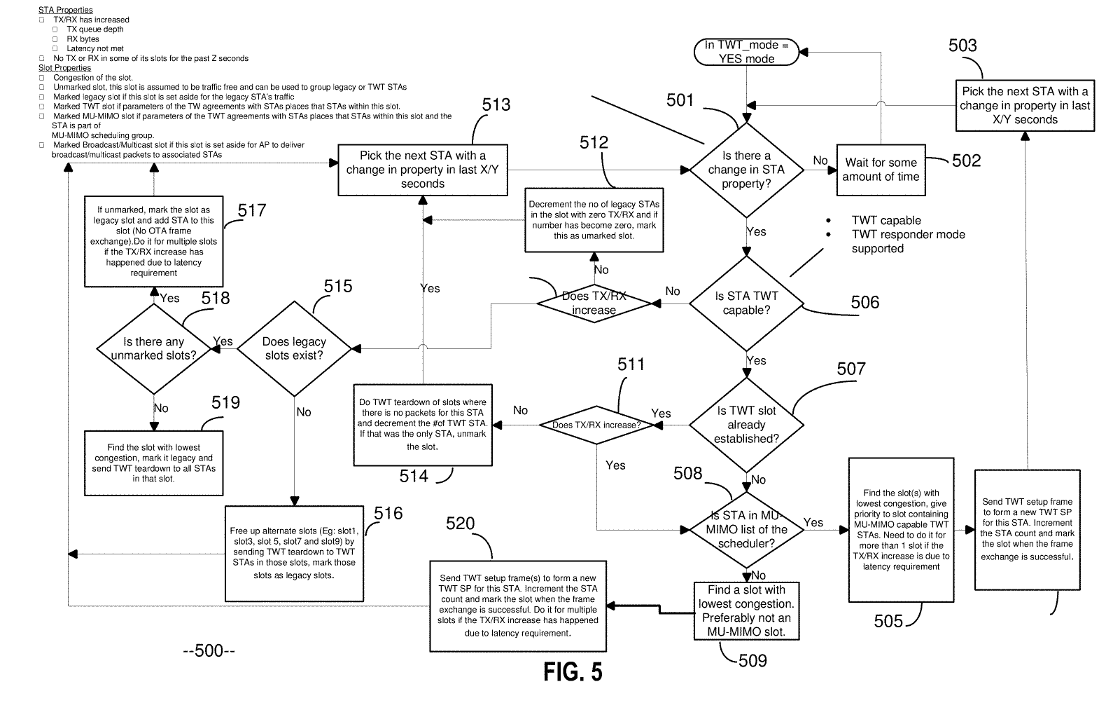

FIG. 5 depicts a process flow 500 that may be used in conjunction with the process flow 400 at steps 405, which the AP has begun establishing TWT agreements with the STAs in its BSS, and communicate setting the TWT mode to positive (TWT=Yes). In process flow 500, at step 501, a determination is made about whether any changes in the STA's property has taken place since the TWT has been set to positive. Such STA's properties may include:

STA Properties: whether TX/RX of packets has increased; whether TX queue depth has changed; whether still receiving data (RX bytes); whether Latency has not met; whether TX or RX of data packets has not taken place over the previous number of seconds (e.g. 5 seconds,) in one or more of the assigned time slots.

STA assigned Slot Properties: whether traffic Congestion of the STA assigned slot is present; whether the slot is an unmarked slot, this slot is assumed to be traffic free and can be used to group legacy or TWT STAs; whether the slot is marked legacy slot if this slot is set aside for the legacy STA's traffic; whether the slot is marked TWT slot if parameters of the TW agreements with STAs places that STAs within this slot; whether the slot is marked MU-MIMO slot if parameters of the TWT agreements with STAs places that STAs within this slot and the STA is part of MU-MIMO scheduling group; whether the slot is marked Broadcast/Multicast slot if this slot is set aside for AP to deliver broadcast/multicast packets to associated STAs.

At step 501, if there has not been a change in the STA's property, the process flow loops back, and if the TWT mode is still positive, the evaluation at step 501 is repeated. If there has been a change in the STA's property at step 501, the process flow 500 moves to step 506. At step 506, the process determines whether the STA is an STA capable of operating in accordance with the TWT protocols (i.e. an advanced STA). If the STA is able to operate with TWT protocols, the process flow moves to step 507 to determine if there is already an established TWT slot (i.e. TWT slots #1-8 as shown in FIG. 2). If there is no available TWT slot, the process flow moves to step 508 to determine whether the STA is operating in MU-MIMO mode. If the STA is operating in MU-MIMO mode, the process flow moves to step 505 to find a time TWT slot for assignment to the STA. Considering at this point of the process flow no TWT slot has been available for assigning to the STA, the process at step 505 involves reassigning the priority provided to the STAs already assigned in the TWT slots (e.g. slots #1-8). Generally, the total number of TWT slots depends on the beacon interval and each slot duration within the beacon interval timing. As such, the number of TWT slots may be different in different implementations. In the example provided (i.e. TWT slots #1-8), to make one or more TWT slot available for the STA in MU-MIMO mode, one or more existing STAs assigned in TWT slots #1-8 may be given a lower priority and dropped off from the TWT slots #1-8 assignment to make transmission time available for the STA in MU-MIMO mode. If the STA property change determined at step 501 is due to lack meeting certain latency requirement, more than one TWT slot may be assigned to the STA in MU-MIMO mode at this point. At step 504, the process flow establishes a new TWT slot service period assignment, and communicates the new TWT assignment to the STA. The process flow from step 504 moves to step 503 for determining the next STA that its property has changed in the last few seconds (e.g. 5 seconds). If there is an STA with a changed property, the process flow moves to step 501, and the process is repeated.

At step 507, if there is an available TWT time slot, the process moves to step 510 for determining if there is an increase in TX/RX packets as a result of assigning the STA to a TWT time slot. If there is an increase, the process flow moves to step 508 to determine whether the STA is operating in MU-MIMO mode. If the STA is not operating in MU-MIMO mode, the process moves to step 509 for selecting a TWT slot with the lowest congestion level (i.e. less active slot). It is preferred to select a TWT slot that has not been assigned to a STA for MU-MIMO communication. Once a TWT slot has been selected at step 509, the process flow moves to step 520 for formulation of one or more new TWT slots service period assignment, and communicate the same to the STA. Formulation of one or more TWT slots is generally configurable, and the increased number of TWT slots may be based on a percentage of the existing number of TWT slots. In the event an increase in TX/RX packets is due to latency requirement for the STA, more than one TWT slot may be assigned, and communicate the same to the STA. For example, the assigned TWT slots to the STA may be spaced apart every few TWT slots (e.g. two TWT slots (20 mSec.) apart) depending on the application and/or other factors. For example, in case of VoIP application, the TWT slots assigned to the STA may be spaced apart by 20 mSec. because the VoIP packets are spaced apart in a similar timing. At this point the process flow moves to step 513 (i.e. which is the same as step 503) for determining the next STA that its property has changed in the last few seconds. The process flow moves to step 501 if a new STA satisfied the condition for a new TWT assignment, and the process is repeated again at step 501.

At step 510 if there is not an increase in TX/RX packets as a result of assigning the STA to a TWT time slot, the process flow moves to step 514 for formulation of a new TWT slot service period assignment since the STA has no particular data packets to send or receive, and the assigned TWT slot becomes available for other assignments. At this point, the process moves to step 513 (i.e. which is the same as step 503) for determining the next STA that its property has changed in the last few seconds. The process flow moves to step 501 if a new STA satisfies the condition for a new TWT assignment, and the process is repeated again at step 501.

At step 506, if the STA is not an STA capable of operating in accordance with the TWT protocols (i.e. a legacy STA), the process moves to step 511 for determining whether an increase in TX/RX packets for the STA may take place. If there is no increase in TX/RX of data packets, the process flow moves to step 512 for decrementing the number of legacy STAs in the assigned TWT slot, and if the assigned TWT slot, as a result of decrementing the number of legacy STA, has zero number of legacy assigned STAs, the TWT slot is marked as available for new assignment. The process flow moves to step 513 for determining the next STA that its property has changed in the last few seconds. The process flow moves to step 501 if a new STA satisfies the condition for a new TWT assignment, and the process is repeated again at step 501.

At step 511 if there is an increase in TX/RX packets for the STA, the process flow moves to step 515 to determine whether any of the assigned TWT slots is assigned to the legacy STAs has at least one available space for assigning a new legacy STA. If there is no TWT slot available for the legacy STA, the process moves to step 516 for freeing up a new TWT slot for the legacy STA, and for sending a new TWT slot assignment that includes at least one time slot allocated to the legacy STA. AT this point, the process flow moves to step 513 for determining the next STA that its property has changed in the last few seconds. The process flow moves to step 501 if a new STA satisfies the condition for a new TWT assignment, and the process is repeated again at step 501.

At step 515, if there is at least one TWT slot available for the legacy STA, the process moves to step 518 for determining whether among such legacy STA assigned TWT slots at least one time slot is available for assignment to the new legacy STA. If a TWT slot is available, the process moves to step 517 for assignment of the TWT slot to the new legacy STA. In the event the TX/RX packet transmission is increasing due to a latency requirement, more than one TWT slot may be assigned at step 517. The process flow moves to step 513 for determining the next STA that its property has changed in the last few seconds. The process flow moves to step 501 if a new STA satisfies the condition for a new TWT assignment, and the process is repeated again at step 501.

At step 518, if there is not any available legacy STA assigned TWT slots, the process moves to step 519 for selecting a TWT slot with a lowest congestion level, and reassigning the TWT slot to the new STA. At this point, the process flow moves to step 513 for determining the next STA that its property has changed in the last few seconds. The process flow moves to step 501 if a new STA satisfies the condition for a new TWT assignment, and the process is repeated again at step 501.

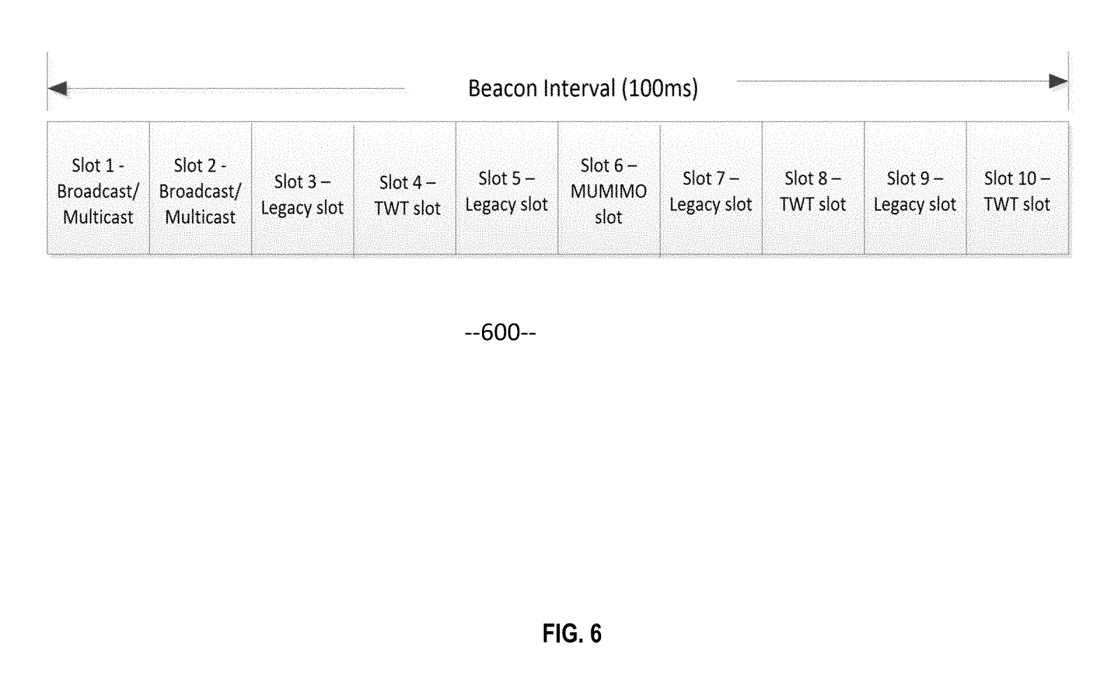

FIG. 6, an exemplary TWT frame 600 having ten slots with various possible TWT assignment formulated and formed in accordance with various aspects of the disclosure is shown. In the exemplary TWT frame 600, slots 3, 5, 7 and 9 are assigned to the legacy STAs, and slots 4, 8 and 10 are assigned to the advanced STAs having capability to operate in accordance with the TWT protocols, and slot 6 is assigned to the advanced STAs having capability to operate in accordance with the TWT protocols and transmitting and receiving in accordance with MU-MIMO communication protocols. As a result, the network 100 operating based on various aspects of the disclosure is able to accommodate communication services for a wide range of capabilities, including legacy STAs, advanced STAs, and advanced STAs with MU-MIMO communications.

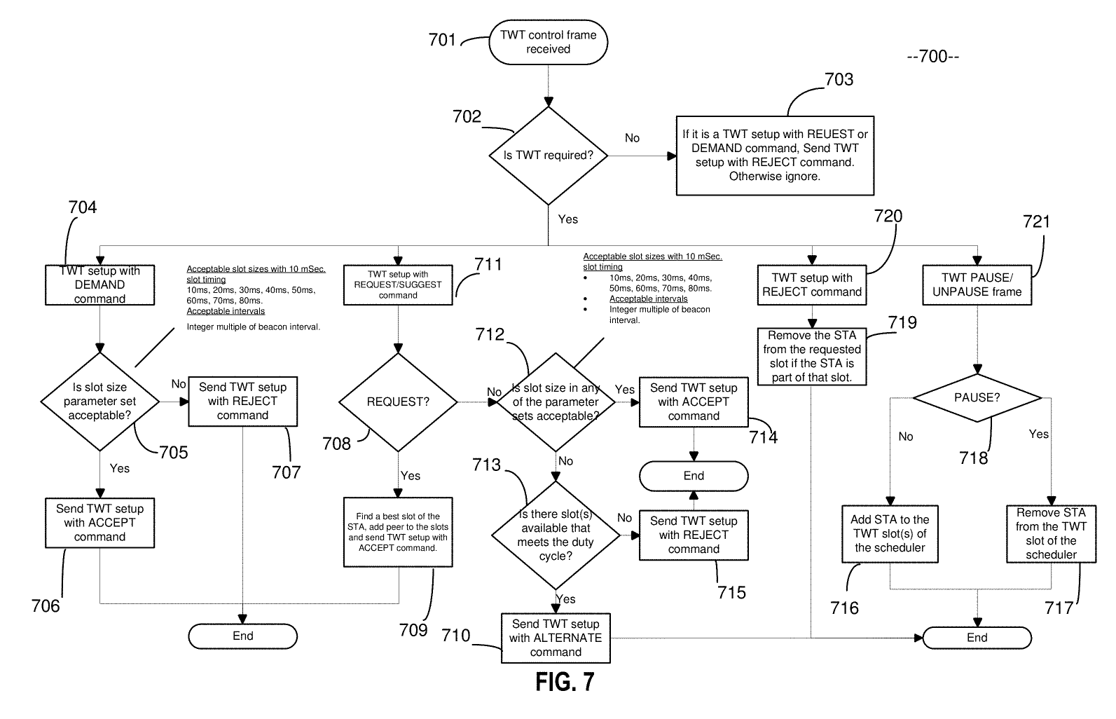

FIG. 7 depicts an exemplary process flow for AP to manage a TWT request from an STA in accordance with various aspects of the disclosure. Considering that the AP has sets its TWT mode to positive (i.e. TWT-Mode=Yes), at step 701 the AP may receive a TWT control frame from an STA. AT step 702, the AP examines the TWT control frame for determining whether setting up a TWT would be required. The process for determining the outcome of step 702 may be in accordance with the process as outlined and explained in relation to the process depicted in FIG. 4. If a TWT is not required at step 702, the process flow moves to step 703 and prepares to send a TWT reject command to the STA. If the STA has sent an explicit TWT setup with REQUEST or DEMAND, the AP may send a response with REJECT to the STA. The AP may explicitly notify the STA that its REQUEST or DEMAND has been rejected. If the STA request has been a suggestion for setting a TWT, the AP may just ignore the suggested request. At step 702, if a TWT is required, the process flow 700 considers a number of possible formulations of the TWT request. If the TWT request from STA is conditioned with a demand command, the process flow moves to step 704. AT step 705, the AP determines whether the STA requested slot size parameter satisfies one of the acceptable slot sizes. For example, with use of 10 mSec slot timing, slot sizes of 10, 20, 30, 40, 50, 60, 70, and 80 mSec. are acceptable slot sizes. With use of 20 mSec. slot timing, slot sizes of 20, 40, 60, 80, etc. mSec. may be used. The interval of the TWT request should also satisfy a criteria of being an integer multiple of the beacon interval. If the requested slot parameters do not satisfy such an exemplary condition, the process flow moves to step 707 and a TWT setup reject command is transmitted to the STA. If the requested slot parameters satisfy such an exemplary condition, the process flow moves to step 706 and TWT setup accept command is transmitted to the STA.

If the TWT request from STA is conditioned with a suggest command, the process flow moves to step 711. At step 708, the AP examines whether it accepts such a TWT request with suggest command. Normally, TWT requests are sent with the STA acceptable set of parameters. AP needs to evaluate such parameters and find one or more slots that could accommodate such STA requested parameters. The AP accept such a TWT setup request when it finds certain slot(s) could accommodate the STA requested parameters. If the AP accepts such a request, the process flow moves to step 709 to find a best slot of the STA, add peer to the slots and send TWT setup with ACCEPT command. If the AP does not accept such a request, the process flow moves to step 712 which determines whether the suggested slot size parameters are acceptable. If the slot size is acceptable, the process flow moves to step 714 and a TWT setup accept command is transmitted to the STA. If at step 712, the slot size parameters are not acceptable, the process flow moves to step 713 to determine if there is any available slot that could meet the duty cycle of the TWT request suggest command. At step 713, if an available slot that meets the suggested duty cycle, a TWT setup accept command is transmitted to the STA at step 710. Otherwise, the process flow moves to step 715 and a TWT setup reject command is transmitted to the STA.

AT step 720, if the TWT request from the STA is actually conditioned to be removed from the TWT setup, the process flow moves to step 719 and the STA is removed from the TWT setup. The TWT request and/or TWT information frame from the STA may actually include a condition that the TWT slot for the STA to be paused for some time. If such a TWT information frame has been received from the STA, the process flow 721 determines at step 721 that such a request has been received. At step 718, the process flow determines if a pause request has been received. If the TWT information frame includes a pause request from the STA, the AP at step 717 would remove the STA from the transmission schedule of packets during such identified TWT slots. At step 718, if the process flow determines that an un-pause request has been received, the AP at step 717 would add the STA to the transmission schedule of packets during such identified TWT slots.

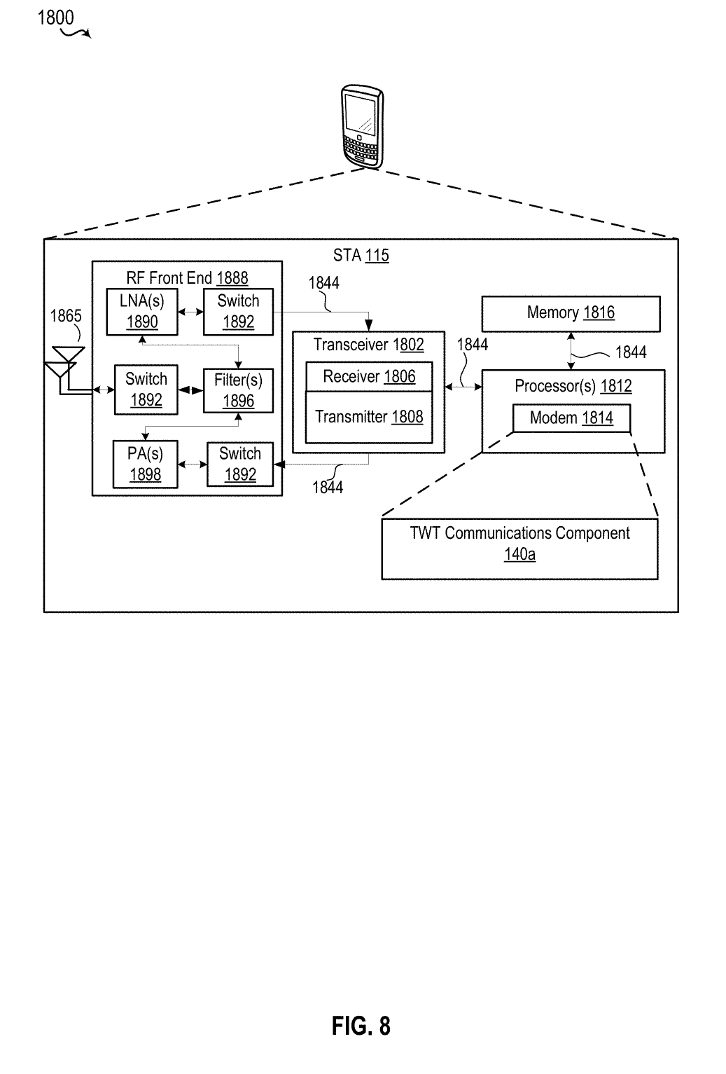

FIG. 8 shows a diagram 1800 that describes hardware components and subcomponents of an STA 115 for implementing the various features described herein in connection with TWT communications, including one or more methods described and claimed herein in accordance with various aspects of the present disclosure. The STA 115 may be an example of the STAs shown in FIG. 1 and described throughout the present disclosure. As described, when an STA is setting up, modifying, or tearing down TWT communications, the components and subcomponents described herein may be used to at least monitor various network operating parameters, initiate and manage TWT communications based on such network parameters, and schedule communications around and during TWT service periods.

One example of an implementation of STA 115 may include a variety of components, some of which have already been described, but including components such as one or more processors 1812, the memory 1816, and the transceiver 1802 in communication via one or more buses 1844, which may operate in conjunction with the TWT communications component 140a to enable one or more of the functions described herein, including the functions related to one or more methods of the present disclosure. Further, the one or more processors 1812, the modem 1814, the memory 1816, the transceiver 1802, the RF front end 1888, and the one or more antennas 1865, may be configured to support voice and/or data calls (simultaneously or non-simultaneously) in one or more radio access technologies. For example, the STA 115 may support a number of applications to interact with the user and the network through an associated access point.

In an aspect, the one or more processors 1812 can include the modem 1814 that uses one or more modem processors. The various functions related to the TWT communications component 140a may be included in modem 1814 and/or processors 1812 and, in an aspect, can be executed by a single processor, while in other aspects, different ones of the functions may be executed by a combination of two or more different processors. For example, in an aspect, the one or more processors 1812 may include any one or any combination of a modem processor, or a baseband processor, or a digital signal processor, or a transmit processor, or a receiver processor, or a transceiver processor associated with transceiver 1802. In other aspects, some of the features of the one or more processors 1812 and/or modem 1814 associated with the TWT communications component 140a may be performed by transceiver 1802.

Also, the memory 1816 may be configured to store data used herein and/or local versions of applications or the TWT communications component 140a and/or one or more of its subcomponents being executed by at least one processor 1812. The memory 1816 can include any type of computer-readable medium usable by a computer or at least one processor 1812, such as random access memory (RAM), read only memory (ROM), tapes, magnetic discs, optical discs, volatile memory, non-volatile memory, and any combination thereof. In an aspect, for example, the memory 1816 may be a non-transitory computer-readable storage medium that stores one or more computer-executable codes defining the TWT communications component 140a and/or one or more of its subcomponents, and/or data associated therewith, when the STA 115 is operating at least one processor 1812 to execute TWT communications component 140a and/or one or more of its subcomponents.

The transceiver 1802 may include at least one receiver 1806 and at least one transmitter 1808. The receiver 1806 may include hardware, firmware, and/or software code executable by a processor for receiving data, the code comprising instructions and being stored in a memory (e.g., computer-readable medium). The receiver 1806 may be, for example, a radio frequency (RF) receiver. In an aspect, receiver 1806 may receive signals transmitted by an AP or another STA. Additionally, the receiver 1806 may process such received signals, and also may obtain measurements of the signals, such as, but not limited to, Ec/Io, SNR, RSRP, RSSI, etc. The transmitter 1808 may include hardware, firmware, and/or software code executable by a processor for transmitting data, the code comprising instructions and being stored in a memory (e.g., computer-readable medium). A suitable example of the transceiver 1802 may include, but is not limited to, an RF transmitter.

Moreover, in an aspect, the STA 115 may include the RF front end 1888, which may operate in communication with the one or more antennas 1865 and the transceiver 1802 for receiving and transmitting radio transmissions. The RF front end 1888 may be connected to the one or more antennas 1865 and can include one or more low-noise amplifiers (LNAs) 1890, one or more switches 1892, one or more power amplifiers (PAs) 1898, and one or more filters 1896 for transmitting and receiving RF signals.

In an aspect, LNA 1890 can amplify a received signal at a desired output level. In an aspect, each LNA 1890 may have a specified minimum and maximum gain values. In an aspect, the RF front end 1888 may use the one or more switches 1892 to select a particular LNA 1890 and its specified gain value based on a desired gain value for a particular application.

Further, for example, one or more PA(s) 1898 may be used by the RF front end 1888 to amplify a signal for an RF output at a desired output power level. In an aspect, each PA 1898 may have specified minimum and maximum gain values. In an aspect, the RF front end 1888 may use the one or more switches 1892 to select a particular PA 1898 and its specified gain value based on a desired gain value for a particular application.

Also, for example, the one or more filters 1896 can be used by the RF front end 1888 to filter a received signal to obtain an input RF signal. Similarly, in an aspect, for example, a respective filter 1896 can be used to filter an output from a respective PA 1898 to produce an output signal for transmission. In an aspect, each filter 1896 can be connected to a specific LNA 1890 and/or PA 1898. In an aspect, the RF front end 1888 can use the one or more switches 1892 to select a transmit or receive path using a specified filter 1896, LNA 1890, and/or PA 1898, based on a configuration as specified by transceiver 1802 and/or processor 1812.

As such, transceiver 1802 may be configured to transmit and receive wireless signals through the one or more antennas 1865 via the RF front end 1888. In an aspect, the transceiver 1802 may be tuned to operate at specified frequencies such that STA 115 can communicate with, for example, other STAs or with an AP. In an aspect, for example, the modem 1814 can configure the transceiver 1802 to operate at a specified frequency and power level based on the configuration of the STA 115 and the communication protocol used by the modem 1814.

In an aspect, the modem 1814 can be a multiband-multimode modem, which can process digital data and communicate with the transceiver 1802 such that the digital data is sent and received using the transceiver 1802. In an aspect, the modem 1814 can be multiband and be configured to support multiple frequency bands for a specific communications protocol. In an aspect, the modem 1814 can be multimode and be configured to support multiple operating networks and communications protocols. In an aspect, the modem 1814 can control one or more components of the STA 115 (e.g., the RF front end 1888, the transceiver 1802) to enable transmission and/or reception of signals based on a specified modem configuration. In an aspect, the modem configuration can be based on the mode of the modem and the frequency band in use.

As described throughout, the TWT communications component 140a may include a number of subcomponents (not shown for clarity) for determining and evaluating various aspects of the network operating parameters, such as congestion, interference level, latency, etc. Component 140a may be configured to communicate with and support the various hardware components of the STA 115. Component 140a may monitor various network operating parameters, such as channel congestion, interference, latency, etc. to identify or obtain certain network operating metrics as explained throughout the disclosure. Component 140a may operate in conjunction with the processors 1812 and/or the modem 1814 to determine whether the such identified network operating metric(s) meets a threshold as explained throughout. Component 140a may be implemented by or may be a subcomponent of the transceiver 1802 and may transmit a request to establish TWT communications in response to determining that such metrics meet the corresponding thresholds. Component 140a may be implemented by the processor 1812, the modem 1814, and/or the transceiver 1802 and may enable the STA 115 to modify or otherwise adjust set-up parameters of the TWT communications such as a service period, a service interval, a wake duration, and other parameters with an associated AP.

Also as described above, the TWT communications component 140a may also include the communications scheduling component (not shown for clarity) which may operate in conjunction with the transceiver 1802, the processors 1812, the modem 1814, and other components to handle scheduling of TWT communications. The communications scheduling component may include various function for terminating a scheduled service period of the TWT communications. The TWT communications component 140a may also include a receiving component (not shown for clarity) which may be implemented by or may be a subcomponent of the transceiver 1802 and may receive and process different types of indications, including indications that there are frames queued for transmission at the STA 115 and indications that there are frames available at an AP for transmission to the STA 115, etc. Further, the TWT communications component 140a may include a transmission component (not shown for clarity) may be implemented by or may be a subcomponent of transceiver 1802 and may transmit to an AP, an indication that a communications link is to remain active between a terminated scheduled service period and a next or second scheduled service period. The scheduling component may prepare frames in a transmission queue for transmission during a TWT service period or in between TWT service periods.

The TWT communications component 140a may also include other components for determining/handling a transmission queues, as well as an uplink/downlink (UL/DL) ping component for handling aspects of the uplink ping and downlink ping operations. The TWT communications component 140a may also include a large traffic component for handling aspects of large traffic operations. Moreover, the TWT communications component 140a may also include an off-channel component for handling aspects of off-channel operations.

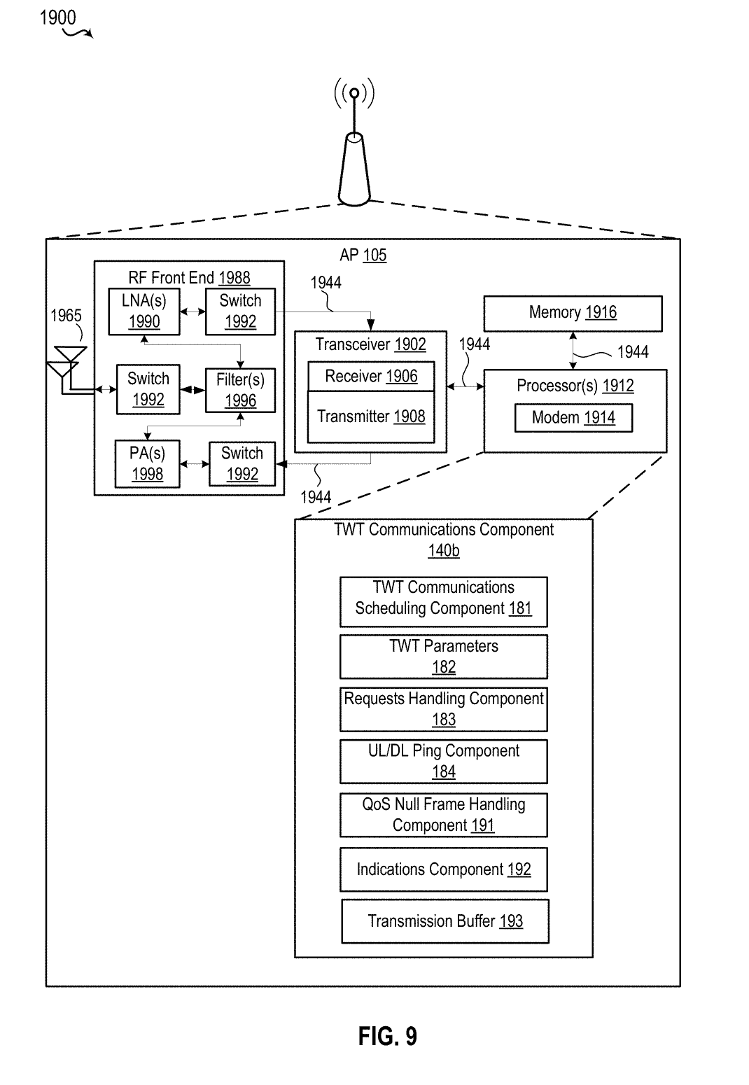

FIG. 9 shows a diagram 1900 that describes hardware components and subcomponents of an AP 105 as described herein in accordance with various aspects of the present disclosure. The AP 105 may be an example of the APs shown in FIG. 1 and described throughout the present disclosure. One example of an implementation of the AP 105 may include a variety of components, some of which have already been described above, but including components such as one or more processors 1912, a memory 1916, and a transceiver 1902 in communication via one or more buses 1944, which may operate in conjunction with the TWT communications component 140b to enable one or more of the functions described in connection with AP operations of the present disclosure. Further, the one or more processors 1912, a modem 1914, the memory 1916, the transceiver 1902, an RF front end 1988, and one or more antennas 1965, may be configured to support voice and/or data calls (simultaneously or non-simultaneously) in one or more radio access technologies. For example, the AP 105 may support various applications for data communications between an associated STA and the wide area network (i.e. internet).

In an aspect, the one or more processors 1912 can include the modem 1914 that uses one or more modem processors. The various functions related to the TWT communications component 140b may be included in the modem 1914 and/or the processors 1912 and, in an aspect, can be executed by a single processor, while in other aspects, different ones of the functions may be executed by a combination of two or more different processors. For example, in an aspect, the one or more processors 1912 may include any one or any combination of a modem processor, or a baseband processor, or a digital signal processor, or a transmit processor, or a receiver processor, or a transceiver processor associated with the transceiver 1902. In other aspects, some of the features of the one or more processors 1912 and/or the modem 1914 associated with the TWT communications component 140b may be performed by the transceiver 1902.

Also, the memory 1916 may be configured to store data used herein and/or local versions of applications or the TWT communications component 140b and/or one or more of its subcomponents being executed by at least one processor 1912. The memory 1916 can include any type of computer-readable medium usable by a computer or at least one processor 1912, such as random access memory (RAM), read only memory (ROM), tapes, magnetic discs, optical discs, volatile memory, non-volatile memory, and any combination thereof. In an aspect, for example, the memory 1916 may be a non-transitory computer-readable storage medium that stores one or more computer-executable codes defining the TWT communications component 140b and/or one or more of its subcomponents, and/or data associated therewith, when the AP 105 is operating at least one processor 1912 to execute the TWT communications component 140b and/or one or more of its subcomponents.

The transceiver 1902 may include at least one receiver 1906 and at least one transmitter 1908. The receiver 1906 may include hardware, firmware, and/or software code executable by a processor for receiving data, the code comprising instructions and being stored in a memory (e.g., computer-readable medium). The receiver 1906 may be, for example, a radio frequency (RF) receiver. In an aspect, the receiver 1906 may receive signals transmitted by an STA or another AP. Additionally, the receiver 1906 may process such received signals, and also may obtain measurements of the signals, such as, but not limited to, Ec/Io, SNR, RSRP, RSSI, etc. The transmitter 1908 may include hardware, firmware, and/or software code executable by a processor for transmitting data, the code comprising instructions and being stored in a memory (e.g., computer-readable medium). For example, when the AP 105 is participating in TWT communications , the AP may transmit and receive frames.

Moreover, in an aspect, the AP 105 may include the RF front end 1988, which may operate in communication with the one or more antennas 1965 and the transceiver 1902 for receiving and transmitting radio transmissions, for example, wireless communications. The RF front end 1988 may be connected to the one or more antennas 1965 and can include one or more low-noise amplifiers (LNAs) 1990, one or more switches 1992, one or more power amplifiers (PAs) 1998, and one or more filters 1996 for transmitting and receiving RF signals.

In an aspect, the LNA 1990 can amplify a received signal at a desired output level. In an aspect, each LNA 1990 may have a specified minimum and maximum gain values. In an aspect, the RF front end 688 may use the one or more switches 1992 to select a particular LNA 1990 and its specified gain value based on a desired gain value for a particular application.

Further, for example, the one or more PA(s) 1998 may be used by the RF front end 1988 to amplify a signal for an RF output at a desired output power level. In an aspect, each PA 1998 may have specified minimum and maximum gain values. In an aspect, the RF front end 1988 may use the one or more switches 1992 to select a particular PA 1998 and its specified gain value based on a desired gain value for a particular application.

Also, for example, the one or more filters 1996 can be used by the RF front end 1988 to filter a received signal to obtain an input RF signal. Similarly, in an aspect, for example, a respective filter 1996 can be used to filter an output from a respective PA 1998 to produce an output signal for transmission. In an aspect, each filter 1996 can be connected to a specific LNA 1990 and/or PA 1998. In an aspect, the RF front end 1988 can use the one or more switches 1992 to select a transmit or receive path using a specified filter 1996, LNA 1990, and/or PA 1998, based on a configuration as specified by the transceiver 1902 and/or the processor 1912.

As such, the transceiver 1902 may be configured to transmit and receive wireless signals through the one or more antennas 1965 via the RF front end 1988. In an aspect, the transceiver 1902 may be tuned to operate at specified frequencies such that the AP 105 can communicate with, for example, one or more STAs 115 or another AP 105. In an aspect, for example, the modem 1914 can configure the transceiver 1902 to operate at a specified frequency and power level based on the configuration of the AP 105 and the communication protocol used by the modem 1914.

In an aspect, the modem 1914 can be a multiband-multimode modem, which can process digital data and communicate with the transceiver 1902 such that the digital data is sent and received using the transceiver 1902. In an aspect, the modem 1914 can be multiband and be configured to support multiple frequency bands for a specific communications protocol. In an aspect, the modem 1914 can be multimode and be configured to support multiple operating networks and communications protocols. In an aspect, the modem 1914 can control one or more components of the AP 105 (e.g., the RF front end 1988, the transceiver 1902) to enable transmission and/or reception of signals based on a specified modem configuration. In an aspect, the modem configuration can be based on the mode of the modem and the frequency band in use.

The TWT communications component 140b may perform functions from the perspective of the AP that complement the functions described herein in connection with the STAs for TWT communications. The TWT communications component 140b may include a TWT communications scheduling component 181 that coordinates the scheduling of TWT communications with one or more STAs. The TWT communications component 140b may also include a TWT parameters 182 for maintaining, updating, revising, accepting, and/or storing TWT parameters. The TWT communications component 140b may also include a requests handling component 183 that receives, processes, and responds to different requests by STAs in connection with TWT communications. The TWT communications component 140b may also include an UL/DL ping component 184 that performs AP-side functions associated with uplink ping and downlink ping operations. The TWT communications component 140b may also include a QoS null frame handling component 191 that receives, processes, and responds to QoS null frames (e.g., QoS null frames with PM 0, QoS null frames with PM 1) from one or more STAs. The TWT communications component 140b may also include an indications component 192 that generates and transmits (e.g., via the transceiver 1902 and/or the RF front end 1988) one or more indications to an STA, including indications (e.g., beacons) that convey the presence of one or more frames in transmission buffers 193 for transmission to the STA. Each of the various subcomponents of the TWT communications component 140b may operate independently or may operate in conjunction with one or more other subcomponents of the TWT communications component 140b.

The above detailed description set forth above in connection with the appended drawings describes examples and does not represent the only examples that may be implemented or that are within the scope of the claims. The various illustrative blocks and components described in connection with the disclosure herein may be implemented or performed with a specially-programmed device, such as but not limited to a processor, a digital signal processor (DSP), an ASIC, a FPGA or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. Computer-readable media includes both computer storage media and communication media including any medium that facilitates transfer of a computer program from one place to another. A storage medium may be any available medium that can be accessed by a general purpose or special purpose computer.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. A method of Target Wake Time (TWT) slot scheduling in a communication network, comprising:
determining a number of stations in a basic service set (BSS) of an access point (AP) exceeding a minimum number of stations;
determining whether to establish the TWT slot scheduling for at least one or more of the stations based on one or more operational condition of the communication network; and
establishing the TWT slot scheduling of the least one or more of the stations if the one or more operational condition of the communication network, individually or collectively, satisfy a threshold.

2. The method as recited in claim 1 wherein the one or more operational condition of the communication network includes at least one of network congestion level, interference level, transmit queue depth of one or more of the stations, number of receive packets from one or more of the stations during a particular period of time, latency requirement of an application being used by one or more of the stations, and allowing use of a communication medium among the stations based on an air time fairness criteria.

3. The method as recited in claim 1 wherein the one or more operational condition of the communication network includes congestion and interference levels of the communication network, and satisfying the threshold includes the congestion level to be above a threshold and the interference level be below a threshold.

4. The method as recited in claim 1 wherein the one or more operational condition of the communication network, individually or collectively, satisfy the threshold, determining if the number of stations in the BSS of the access point AP includes at least one legacy station, and assigning at least one TWT slot to the least one legacy station.

5. The method as recited in claim 1 wherein the one or more operational condition of the communication network, individually or collectively, satisfy the threshold, determining if the number of stations in the BSS of the access point AP includes at least one MU-MIMO station, and assigning at least one TWT slot to the least one MU-MIMO station.

6. The method as recited in claim 1 wherein the one or more operational condition of the communication network, individually or collectively, satisfy the threshold, rescheduling the TWT slots for at least one or more of the stations based on whether a communication property at one or more the stations has changed after a last established TWT slot scheduling of the one or more of the stations.

7. The method as recited in claim 6 wherein the rescheduling the TWT slots includes removing, adding, and/or modifying the scheduled TWT slots to one or more of the stations.

8. The method as recited in claim 1 wherein the one or more operational condition of the communication network, individually or collectively, satisfy the threshold, rescheduling the TWT slots for at least one or more of the stations based on a request from the one or more stations.

9. The method as recited in claim 8 wherein the request from the one or more stations includes at least one of TWT setup with DEMAND command, TWT setup with REQUEST/SUGGEST command, TWT setup with REJECT command, and TWT setup with PAUSE/UNPAUSE command.

10. The method as recited in claim 1 wherein the established TWT slot scheduling of the one or more of the stations includes assigning more than one TWT slot and/or TWT slots with a particular duty cycle to a particular station of the one or more stations based on data communication requirement of an application being used by the particular station.

11. The method as recited in claim 10 wherein the data communication requirement of the application includes communication latency requirement, and amount of data being communicated in one beacon interval.

12. An apparatus for Target Wake Time (TWT) slot scheduling in a communication network, the apparatus including a transceiver for communication of data, a processor for processing receive and transmit data, and a memory coupled with the processor, the processor being configured to:
determining a number of stations in a basic service set (BSS) of an access point (AP) exceeding a minimum number of stations;
determining whether to establish the TWT slot scheduling for at least one or more of the stations based on one or more operational condition of the communication network; and
establishing the TWT slot scheduling of the least one or more of the stations if the one or more operational condition of the communication network, individually or collectively, satisfy a threshold.

13. The apparatus as recited in claim 12 wherein the one or more operational condition of the communication network includes at least one of network congestion level, interference level, transmit queue depth of one or more of the stations, number of receive packets from one or more of the stations during a particular period of time, latency requirement of an application being used by one or more of the stations, and allowing use of a communication medium among the stations based on an air time fairness criteria.

14. The apparatus as recited in claim 12 wherein the one or more operational condition of the communication network includes congestion and interference levels of the communication network, and satisfying the threshold includes the congestion level to be above a threshold and the interference level be below a threshold.

15. The apparatus as recited in claim 12 wherein the one or more operational condition of the communication network, individually or collectively, satisfy the threshold, determining if the number of stations in the BSS of the access point AP includes at least one legacy station, and assigning at least one TWT slot to the least one legacy station.

16. The apparatus as recited in claim 12 wherein the one or more operational condition of the communication network, individually or collectively, satisfy the threshold, determining if the number of stations in the BSS of the access point AP includes at least one MU-MIMO station, and assigning at least one TWT slot to the least one MU-MIMO station.

17. The apparatus as recited in claim 12 wherein the one or more operational condition of the communication network, individually or collectively, satisfy the threshold, rescheduling the TWT slots for at least one or more of the stations based on whether a communication property at one or more the stations has changed after a last established TWT slot scheduling of the one or more of the stations.

18. The apparatus as recited in claim 17 wherein the rescheduling the TWT slots includes removing, adding, and/or modifying the scheduled TWT slots to one or more of the stations.

19. The apparatus as recited in claim 12 wherein the one or more operational condition of the communication network, individually or collectively, satisfy the threshold, rescheduling the TWT slots for at least one or more of the stations based on a request from the one or more stations.

20. The apparatus as recited in claim 19 wherein the request from the one or more stations includes at least one of TWT setup with DEMAND command, TWT setup with REQUEST/SUGGEST command, TWT setup with REJECT command, and TWT setup with PAUSE/UNPAUSE command.

21. The apparatus as recited in claim 12 wherein the established TWT slot scheduling of the one or more of the stations includes assigning more than one TWT slot and/or TWT slots with a particular duty cycle to a particular station of the one or more stations based on data communication requirement of an application being used by the particular station.

22. The apparatus as recited in claim 21 wherein the data communication requirement of the application includes communication latency requirement, and amount of data being communicated in one beacon interval.

23. A computer-readable medium having stored instructions to cause a processor to perform Target Wake Time (TWT) slot scheduling communications, the computer-readable medium comprising instructions for:
determining a number of stations in a basic service set (BSS) of an access point (AP) exceeding a minimum number of stations;
determining whether to establish the TWT slot scheduling for at least one or more of the stations based on one or more operational condition of the communication network; and
establishing the TWT slot scheduling of the least one or more of the stations if the one or more operational condition of the communication network, individually or collectively, satisfy a threshold.
